(19) United States
(12) Patent Application Publication
(10) Pub. No.: US 2024/0330254 A1
(43) Pub. Date: Oct. 3, 2024

(54) TECHNIQUES FOR DETECTING DATA DRIFTS AT SCALE

(71) Applicant: VIANAI SYSTEMS, INC., Palo Alto, CA (US)

(72) Inventor: Wasim SADIQ, Pullenvale (AU)

(21) Appl. No.: 18/614,423

(22) Filed: Mar. 22, 2024

Related U.S. Application Data
(60) Provisional application No. 63/492,461, filed on Mar. 27, 2023.
(60) Provisional application No. 63/511,988, filed on Jul. 5, 2023.

(51) Int. Cl. G06F 16/215; G06F 16/2455; G06F 16/25; G06N 5/04

(52) U.S. Cl. CPC G06F 16/215; G06F 16/24552; G06F 16/24556; G06F 16/258; G06N 5/04

(57) ABSTRACT

One embodiment of a method for detecting data drifts includes generating first data by joining inference data output by a trained machine learning model with ground truth data corresponding to the inference data based on one or more identifier keys, performing one or more aggregation operations on the first data to generate second data, and computing a data drift based on the second data.

### CROSS-REFERENCE TO RELATED APPLICATIONS

This application claims priority benefit of the United States Provisional patent Application titled, “TECHNIQUES FOR DETECTING DATA DRIFTS AT SCALE,” filed on Mar. 27, 2023, and having Ser. No. 63/492,461 and the United States Provisional Patent Application titled, “TECHNIQUES FOR DETECTING DATA DRIFTS AT SCALE,” filed on Jul. 5, 2023, and having Ser. No. 63/511,988. The subject matter of these related applications is hereby incorporated herein by reference.

### BACKGROUND

### Field of the Various Embodiments

The embodiments of the present disclosure relate generally to the fields of computer science, machine learning, and artificial intelligence, and more specifically, to techniques for detecting data drifts at scale.

### DESCRIPTION OF THE RELATED ART

Machine learning can be used to discover trends, patterns, relationships, and/or other attributes related to large sets of complex, interconnected, and/or multidimensional data. To glean insights from large data sets, regression models, artificial neural networks, support vector machines, decision trees, naïve Bayes classifiers, and/or other types of machine learning models can be trained using input-output pairs in the data. In turn, the discovered information can be used to guide decisions and/or perform actions related to the data and/or other similar data.

Conventional machine learning models are oftentimes trained on samples of real-world datasets representing events that have occurred in the past. Once trained, the machine learning models can be tested and validated against new events that the machine learning models were not trained on. Based on the validation results, the machine learning models can be iteratively enhanced by adjusting parameters of the machine learning models until acceptable levels of performance are achieved.

After a trained machine learning model is deployed to make predictions on new data, that machine learning model can continue to predict within accepted levels of performance if the patterns and distributions of the new data do not deviate significantly from the training data used to train the machine learning model. However, when the data patterns change, the performance of the machine learning can deteriorate, and the machine learning model can begin to make incorrect predictions. Such changes in data patterns are sometimes referred to as data “drifts.”

One conventional approach for detecting data drifts computes the statistical distance between distributions of data used to train a machine learning model and distributions of data provided to the trained machine learning model after deployment. One drawback of computing such a statistical distance is the amount of data that is used to train the machine learning model and/or that is provided to the trained machine learning model is oftentimes enormous. For example, computing the statistical distance could involve trillions of data points in some scenarios. In such cases, computing the statistical distance can require a very large amount of computational resources and/or time.

One approach for reducing the computational resources and/or time required to compute the statistical distance between distributions of data used to train a machine learning model and distributions of data provided to the trained machine learning model is to reduce the amount of data by sampling a small amount of the distributions of data from the overall data. One drawback of using a small sample of data to compute the statistical distance is that the computed results can be incorrect when the small sample of data is missing critical data drift patterns that are present in the overall data.

As the foregoing illustrates, what is needed in the art are more effective techniques for detecting data drift.

### SUMMARY

One embodiment of the present disclosure sets forth a computer-implemented method for detecting data drifts. The method includes generating first data by joining inference data output by a trained machine learning model with ground truth data corresponding to the inference data based on one or more identifier keys. The method further includes performing one or more aggregation operations on the first data to generate second data. In addition, the method includes computing a data drift based on the second data.

Other embodiments of the present disclosure include, without limitation, one or more computer-readable media including instructions for performing one or more aspects of the disclosed techniques as well as one or more computing systems for performing one or more aspects of the disclosed techniques.

One technical advantage of the disclosed techniques relative to the prior art is, with the disclosed techniques, data drifts can be detected and performance metrics for trained machine learning model can be computed more accurately than using conventional techniques that rely on data sampling, which can miss critical data drift patterns in the overall data. With the disclosed techniques, all available data points can be considered when computing data drifts. In addition, the disclosed technique can be implemented to detect data drifts and compute performance metrics on commodity hardware, as opposed to specialized computing infrastructure. In that regard, the disclosed techniques make efficient use of available processors and/or cores and memory in a computing system, with the performance increasing linearly as more computing power is made available. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be found by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computing device according to one or more aspects of the present disclosure;

FIG. 2 is a more detailed illustration of the drift detection application of FIG. 1, according to various embodiments;

FIG. 3 is a more detailed illustration of the column store database engine of FIG. 1 according to various embodiments;

FIG. 4 is a flow diagram of method steps for detecting data drifts and computing performance metrics at scale, according to various embodiments;

FIG. 5 is a flow diagram of method steps for data ingestion, according to various embodiments;

FIG. 6 is a flow diagram of method steps for generating summary tables, according to various embodiments;

FIG. 7 is a flow diagram of method steps for generating and executing queries, according to various embodiments; and

FIG. 8 is a flow diagram of method steps for processing a compute request and caching reusable results, according to various embodiments.

### DETAILED DESCRIPTION

In the following description, numerous specific details are set forth to provide a more thorough understanding of the various embodiments. However, it will be apparent to one skilled in the art that the inventive concepts can be practiced without one or more of these specific details.

### System Overview

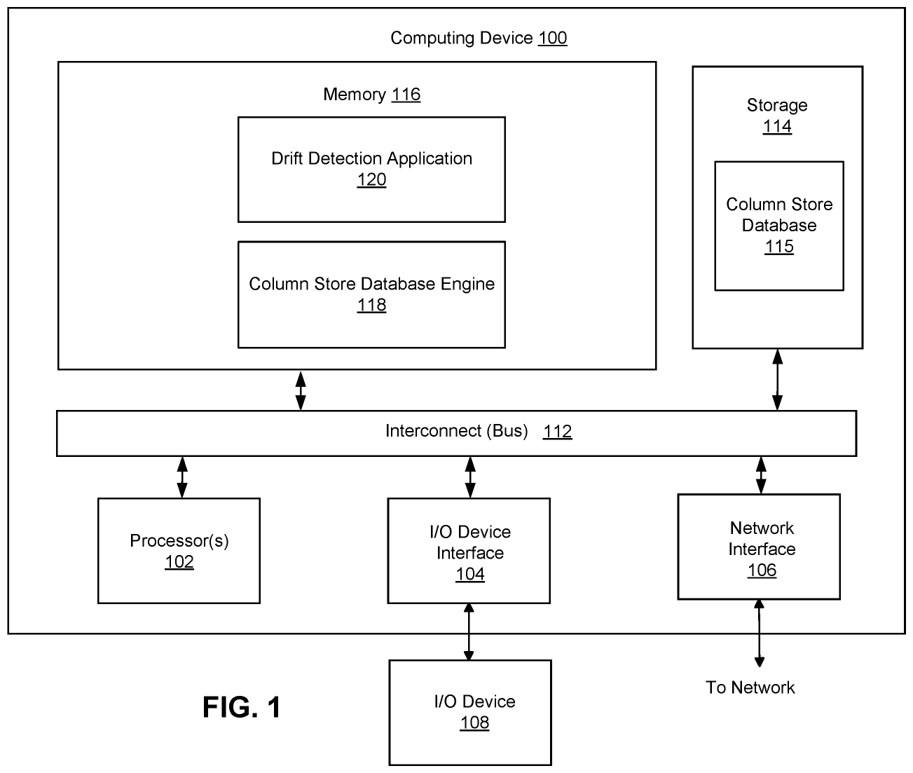

FIG. 1 is a block diagram of a computing device 100 according to one or more aspects of the present disclosure. Computing device 100 can be a desktop computer, a laptop computer, a smart phone, a personal digital assistant (PDA), tablet computer, server machine, or any other type of computing device configured to receive input, process data, and optionally display images, and is suitable for practicing one or more embodiments of the present disclosure. Computing device 100 is configured to run a drift detection application 120 and a column store database engine 118 that resides in a memory 116 of computing device 100.

It is noted that computing device 100 described herein is illustrative and that any other technically feasible configurations fall within the scope of the present disclosure. For example, multiple instances of drift detection application 120 and/or column store database engine 118 could execute on a set of nodes in a data center, cluster, or cloud computing environment to implement the functionality of the computing device 100. In another example, drift detection application 120 and/or column store database engine 118 could be implemented using any number of hardware and/or software components or layers.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114 that stores a column store database 115, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, the processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

In one embodiment, the I/O devices 108 include devices capable of receiving input, such as a keyboard, a mouse, a touchpad, and/or a microphone, as well as devices capable of providing output, such as a display device and/or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In some embodiments, network 110 is any technically feasible type of communications network that allows data to be exchanged between computing device 100 and external entities or devices, such as a web server or another networked computing device. For example, network 110 could include a wide area network (WAN), a local area network (LAN), a wireless (WiFi) network, and/or the Internet, among others.

In some embodiments, storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Drift detection application 120 and column store database engine 118 can be stored in storage 114 and loaded into memory 116 when executed.

In some embodiments, memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by the processor(s) 102 and application data associated with said software programs, including drift detection application 120 and column store database engine 118.

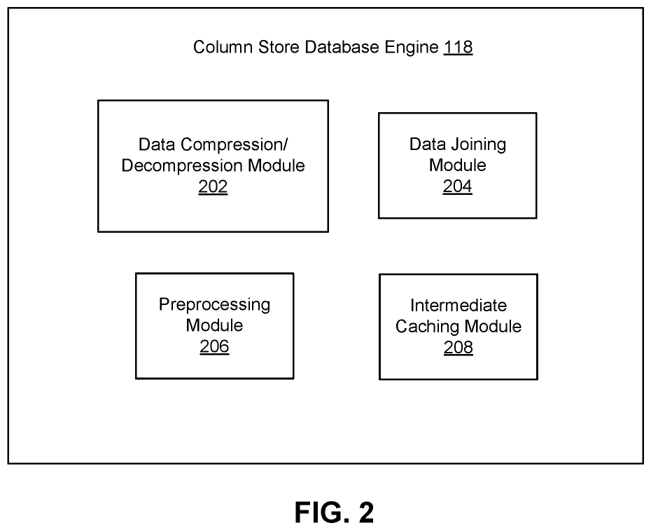

Column store database engine 118 processes, stores, retrieves, and manages data in column store database 115. In some embodiments, column store database engine 118 operates as an interface between column store database 115 and application programs, such as drift detection application 120. In some embodiments, column store database engine 118 is responsible for storing machine learning model predictions (also referred to herein as “inferences”) in column store database 115, compressing raw data in column store database 115, merging ground truth data with machine learning model predictions to create joined tables in column store database 115, decompressing joined tables, computing and storing intermediate results in summary tables, and implementing a caching technique for detecting data drifts and/or computing performance metrics, as discussed in greater detail below in conjunction with FIGS. 2 and 4-8.

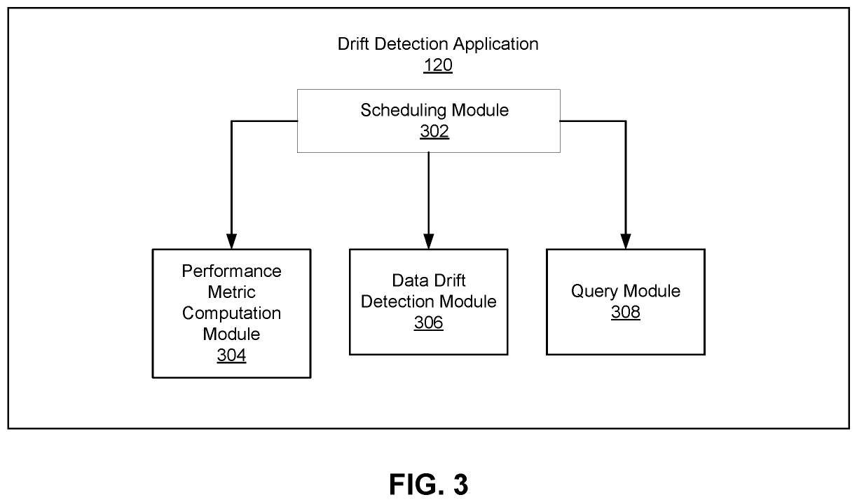

Drift detection application 120 coordinates operations performed by drift detection application 120 and/or column store database engine 118, detects data drifts between distributions of data used to train machine learning models and distributions of data when the trained machine learning models are deployed to make inferences, computes performance metrics to monitor accuracy of the trained machine learning models during the lifetimes of those machine learning models, and generates queries for performing operations and retrieving data from column store database 115, as discussed in greater detail below in conjunction with FIGS. 3-8.

### Detecting Data Drifts at Scale

FIG. 2 is a more detailed illustration of the detail column store database engine 118 of FIG. 1, according to various embodiments. As shown, column store database engine 118 includes, without limitation, a data compression/decompression module 202, a data joining module 204, a pre-processing module 206, and an intermediate caching module 208.

As described, receiving a large number of datapoints associated with many features can create a bottleneck when those datapoints are stored in and retrieved from storage (e.g., storage 114). As storage is typically the slowest computation component in a data processing task, compressing data can facilitate reading more data from slower storage systems during processing of a large number of datapoints associated with many features. In some embodiments data compression/decompression module 202 compresses data using a combination of compression codecs and table schema design parameters that are fine-tuned for the specific requirements of a given data drift computation. In some embodiments, data compression/decompression module 202 dynamically defines schemas of tables to store pre-processed data for each type of inference data generated by one or more machine learning models, which can be any technically feasible type of machine learning model(s) (e.g., artificial neural networks, large language models (LLMs), regression models, support vector machines, decision trees, naïve Bayes classifiers). In addition, compression codecs can be selected to achieve high compression ratios and a desired balance between storage requirements and computation efforts, since data compression requires performing compression at the time of ingestion and decompression at the time of query processing.

In some embodiments, data compression/decompression module 202 stores compressed data in a columnar storage format in which data associated with each feature is stored separately. Storing data in a columnar storage format in which data associated with features are stored separately facilitates reading data for specific features during processing in an efficient manner, since data drift and performance metric computations are oftentimes performed on individual features separately. In some embodiments, known compression techniques can be used to compress feature data for storage in column store database 115. In some embodiments, data to be stored in column store database 115 can be ordered in a manner that maximizes compression of the data, and the particular ordering will generally depend on the compression technique used.

Data joining module 204 joins compressed raw predictions with newly received ground truth data during an ingestion process. The joining process is particularly important in cases where the ground truth data corresponding to machine learning inferences are received at a later point in time than the inferences were made. Although column store databases offer high query performance, column store databases oftentimes do not permit already ingested and compressed data to be updated easily. Data joining module 204 overcomes such limitations by creating four inference mapping tables for each set of machine learning models that take the same input features and generate the same output features: an inference table, a key table, a ground truth table, and a joined table (not shown).

Data joining module 204 populates the inference table with machine learning model predictions. Data joining module 204 associated a timestamp with each inference, and the timestamp can be used to select inferences within a specified time window. In some embodiments, each inference is assigned a unique identifier that is used to join the inference with ground truth data when the ground truth data is ingested at a later time.

Data joining module 204 creates the key table to permit data to be joined using the unique identifier key, described above, instead of timestamps. The unique identifier key is needed when timestamp is used as the primary key in the inference table. The timestamps of corresponding ground truth data may be different if the ground truth data is received at a later time. Accordingly, a different identifier key is used to allow selecting inference data and group truth data using the identifier key for the purposes of joining such data. After the ground truth data is received, data joining module 204 (1) populates the ground truth table; and (2) at regular intervals, joins new ground truth table rows with corresponding inference table rows using corresponding identifier keys, and populates the resulting data in the joined table. In some embodiments, data joining module 204 can perform an optimized joining technique that is able to handle the joining of rows from underlying inference and ground truth tables with a large number of rows. In such cases, the joining technique, which can be executed at specified time intervals and insert newly joined rows from the inference and ground truth tables into the joined table, can be implemented according to the following high-level pseudo-SQL (structured query language) code:

```
-- Joining inferences with ground truth
insert into joined_table
  (joined_table_columns)
with ground_truth as
(
  select identifier_columns, received_timestamp, groundtruth_col
  from groundtruth_table
  where received_timestamp between selected_time_window
),
keys as
(
  select timestamp_col, identifier_columns
  from key_table
  where identifier_columns in (select identifier_columns from
  ground_truth)
)
select joined_table_columns
from inference_table
  inner join ground_truth on join_condition
    where (timestamp_col, identfier_columns) in (select timestamp_col,
    identfier_columns from keys)
```

Pre-processing module 206 is responsible for pre-processing compressed data at the granularity of a specific time interval, such as a time interval of one day. Pre-processing module 206 stores aggregated intermediate results in summary tables to avoid re-computation of intermediate results that can be reused multiple times by different computation jobs. In some embodiments, pre-processing module 206 identifies common intermediate results that can potentially be used more than once by drift computation queries or performance metric computation queries. Pre-processing module 206 can also identify common intermediate results where source data used to compute the intermediate results is immutable. In some embodiments, pre-processing module 206 computes and stores intermediate results at specified time intervals in one or more summary tables in column store database 115, where source data is also stored. For example, the specified time interval could be daily, in which case a pre-processing job that is initiated on one day could process all data that has been ingested and joined on a previous day and append the aggregated data into one or more summary tables. In some embodiments, pre-processing is performed on data that has already been ingested into the column store database 115 and, therefore, does not need to be moved out of the column store database system. In some embodiments, the pre-processed data can be aggregated at specified time intervals (e.g., daily after all inference and ground truth data for a day have been received) according to the following high-level pseudo-SQL code:

```
-- Populating preprocessed values
insert into preprocessed_value_table
  (feature_name, window_date, feature_value, count)
select feature_name, window_date, feature_value, count( )
from inference_table
where window_date = selected_window_date and feature_name =
selected_feature_name
    group by feature_name, window_date, feature_value
```

Pre-processing module 206 can adjust the precision of numerical features before aggregating feature data in summary tables to achieve a desired balance between accuracy and performance. In some embodiments, pre-processing module 206 can make use of all the CPU cores of the underlying system and make use of all the memory available in parallel processing, which can linearly scale summary table computations by scaling up or scaling out underlying database servers. In some embodiments, pre-processing module 206 uses column store database 115 for storing summary tables similar to stored tables in the ingestion phase to benefit from high throughput and reduced computation costs.

In some embodiments, for categorical features of ingested data, pre-processing module 206 computes value counts and stores the results in summary tables. In some embodiments, for continuous features of ingested data by, pre-processing module 206 quantizes values and stores the results in summary table. For example, in some embodiments, the quantization can include rounding the values of continuous features. In some embodiments, the value count bins for categorical and continuous features can be computed according to the following high-level pseudo-SQL code:

-- Computing value count bins for categorical features
select value, sum(count) as count
from preprocessed_value_table
where feature_name = selected_feature_name and
window_date_condition
group by value
order by value

```
-- Computing decile bins for continuous features
with grouped as
(
  select value, sum(count) as count
  from preprocessed_value_table
  where feature_name = selected_feature_name and
  window_date_condition
  group by value
),
cumulative as
(
  select value, count, sum(count) over (order by value) as cum_count
  from grouped
),
(
  select sum(count)
  from cumulative
) as overall_count,
deciles as
(
  select value, count, cum_count, ceil(cum_count / overall_count * 10)
  as bin
  from cumulative
)
select cast(bin as int) as bin, sum(count) as count,
  min(value) as min, max(value) as max
from deciles
group by bin
order by bin
```

In some embodiments, pre-processing module 206 considers underlying machine learning models, data segments, and the data types of feature types when aggregating value counts. For example, depending on whether the underlying machine learning model is for classification or regression, different techniques could be used to aggregate values and generate summary tables. In some embodiments, pre-processed classification metrics and regression metrics can be aggregated according to the following high-level pseudo-SQL code:

-- Populating preprocessed classification metrics
insert into preprocessed_classification_table}
(window_date, received_date, actual_value, predicted_value, count)
select window_date, received_date, actual_value, predicted_value,
count( )
from joined_table
where received_date = selected_window_date
group by window_date, received_date, actual_value, predicted_value
order by window_date, received_date, actual_value, predicted_value

```
-- Populating preprocessed regression metrics
insert into preprocessed_regression_table
  (window_date, received_date, m1, m2, m3, m4, m5, m6, m7, m8, m9,
  m10)
select window_date, received_date,
  count( ) as m1,
  sum(actual_value) as m2,
  sum(power(actual_value, 2)) as m3,
  sum(power(predicted_value, 2)) as m4,
  sum(actual_value − predicted_value) as m5,
  sum(abs(actual_value − predicted_value)) as m6,
  sum(if(actual_value = 0, 0, abs((actual_value − predicted_value) /
actual_value))) as m7,
  sum(power(actual_value − predicted_value, 2)) as m8
  max(actual_value − predicted_value) as m9,
  max(abs(actual_value − predicted_value)) as m10
from joined_table
where received_date = selected_window_date
group by window_date, received_date
```

Intermediate caching module 208 caches results that have already been computed and reuses the cached results when needed to improve query execution performance. In some embodiments, intermediate caching module 208 also permits users to override the caching mechanism and recompute and refresh results. The recomputation of results can be useful in cases where a subset of past data was missing during an earlier ingestion and was ingested at a later point in time. Intermediate caching module 208 executes a caching mechanism in the pre-processing step as well as the compute step to facilitate the “compute once” and “reuse intermediate results multiple times” technique.

Intermediate caching module 208 transforms each compute request into an input representation of parameters in a predefined format. In some embodiments, intermediate caching module 208 generates a unique hash key for each input compute request and searches for the hash key in caching tables to check if the same computation has been performed in the past. If the same computation has been performed in the past, then intermediate caching module 208 fetches results from the prior computation from the caching tables and reuses the fetched results. If the same computation has not been performed in the past, a new computation is performed. When the computation of the new request is completed, a result of the computation is transformed into a predefined format. A unique hash key of the input compute request is used to store input parameters file and the computation result in one or more cache tables in the database. The caching tables can also store results at different levels of granularity for computation requests (e.g., specific computation chunks and complete requests granularities).

FIG. 3 is a more detailed illustration of the drift detection application 120 of FIG. 1, according to various embodiments. As shown, drift detection application 120 includes, without limitation, a scheduling module 302, a performance metric computation module 304, a data drift detection module 306, and a query module 308.

Scheduling module 302 schedules pre-defined events at certain times to invoke performance metric computation module 304, data drift detection module 306, and query module 308 according to policies that meet user requirements. In some embodiments, scheduling module 302 can also invoke performance metric computation module 304, data drift detection module 306, and query module 308 at any time a user requests to compute specific ad-hoc policies. In some other embodiments, scheduling module 302 can invoke data joining module 204 at specific time intervals to merge ground truth data received at the time with previous raw prediction data. In some embodiments, scheduling module 302 can also invoke pre-processing module 206 to compute summary tables at specific time intervals.

Performance metric computation module 304 uses computed summary tables to compute performance metrics on any number of features, segments, and/or time windows. In some embodiments, performance metric computation module 304 can compute baseline histograms, target histograms, drift distances, and/or performance metrics on a variety of features, segments, and/or time windows (e.g., day, week, month, quarter, or any other time windows that each span a set of dates), only using summary tables, without requiring raw data to be processed again. In some embodiments, performance metric computation module 304 uses modifications of known techniques for computing statistical distances between baseline and target data distributions and/or any other intermediate result that have been modified to work on aggregated summary tables rather than raw prediction data. For example, the modifications can be to formulas for computing performance metrics such as confusion matrix, accuracy, precision, mean square error (MSE), root mean squared error (RMSE), mean absolute error (MAE), and/or the like. As a result, performance metrics can be computed using all raw prediction data rather than requiring sampling of the raw prediction data. In some embodiments, performance metric computation module 304 can run drift detection policies covering one or more daily, weekly, monthly, and/or quarterly time spans on all features and/or segments every day, rather than selecting a subset of the policy requirements, as computing everything may not be feasible and/or viable on raw inference data. In some embodiments, the performance metrics can be computed incrementally as more ground truth data becomes available. In some embodiments, performance metric computation module 304 can compute performance metrics on selected user-defined data segments and/or allow computations to take place in as few data scans as possible.

In some embodiments, performance metric computation module 304 can re-use any appropriate cached results that have been previously computed and cached by intermediate caching module 208. For example, a specific baseline histogram could be used for several target histograms. In some embodiments, performance metric computation module 304 considers conditional segments, custom bins, as well as a variety of window parameters in the computations. In some other embodiments, performance metric computation module 304 provides a set of application programming interfaces (APIs) to prepare, cache, and return the results. In some embodiments, performance metrics can be computed for a machine learning model and a specific time window according to the following high-level pseudo-SQL code:

```
-- Compute performance metrics
window_condition = window_date between 2022-10-01 and 2022-12-31
if model_type is classification
  compute classification_metrics by aggregating
preprocessed_classification_table for window_condition
if model_type is regression
  compute regression_metrics by aggregating
preprocessed_aggregation_table for window_condition
return performance_metrics
```

Data drift detection module 306 uses pre-processed summary tables to detect data drifts on a variety of features, segments, and/or time windows depending on whether the drift feature is continuous or categorical. If the data drift exceeds predefined threshold(s), alert(s) can be raised so that users can take appropriate actions. In some embodiments, any technically feasible technique(s) can be used to compute bins and drift metrics. For example, population stability index (PSI), Jenson-Shannon Divergence, Kolmogorov-Smirnov Test, and/or Wasserstein Matrix can be used in some embodiments. In some embodiments, data drift detection module 306 can use modifications of known techniques for computing statistical distances between baseline and target data distributions and/or any other intermediate result that are modified to work on summary tables rather than raw prediction data. The modifications permit data drifts to be detected on all of the raw prediction data, rather than requiring data sampling. In some embodiments, data drift detection module 306 can run drift detection policies for a variety of daily, weekly, monthly, and quarterly time spans on all features and segments every day. In some embodiments, data drift detection module 306 can perform data drift detection on selected user-defined data segments and/or allow computations to take place in as few data scans as possible.

In some embodiments, data drift detection module 306 can, whenever appropriate, re-use cached results that have already been computed and cached by intermediate caching module 208. For example, a specific baseline histogram could be re-used to generate several target histograms. In some embodiments, data drift detection module 306 considers conditional segments, custom bins, as well as a variety of window parameters in the computations. In some other embodiments, data drift detection module 306 provides a set of APIs to prepare, cache, and return the results. For example, in some embodiments, a distanced drift including all features of a model on a specific process date can be computed for a machine learning model according to the following high-level pseudo-SQL code:

```
-- Compute distanced drift
process_date = 2023-03-15
baseline_condition = window_date between 2022-10-01 and 2022-12-31
target_condition = window_date between 2023-01-01 and process_date
distance_drift_list = [ ]
for each feature in the model
  compute baseline_bins dataframe using baseline_condition
  compute target_bins dataframe using target_condition
  compute distanced_drift dataframe by joining baseline_bins and
  target_bins dataframe
  append feature distanced_drift dataframes into distanced_drift_list
return distanced_drift_list
```

In some embodiments, performance metric computation module 304 and data drift detection module 306 can use query module 308 to break down computations into segments and execute computations for individual segments via a computation pipeline on several processors and/or cores in parallel, with the results being aggregated into one result when all cores have completed execution. In such cases, query module 308 can also reduce memory usage during computations by individual processors and/or cores to a minimum by generating computation queries that can perform multiple computations in a single data scan. For example, if several different computations are to be performed on a specific subset of data, all such computations could be performed in a single step as data is scanned and read from the database.

Query module 308 translates specific user requirements into dynamically generated queries for execution on an underlying database. In some embodiments, the queries can be generated on the fly based on parameters extracted from user specified requirements. For example, in some embodiments, the user specified requirements can include specific inference features that users want to compute drift and performance on, arbitrarily defined time windows, data segments, and/or hot spots for analysis. Query module 308 breaks down what is required to complete computation of policy requirements into specific computation chunks. Using the computation chunks as building blocks, query module 308 dynamically generates one or more computation queries on the fly to satisfy policy requirements.

Query module 308 formulates queries in a manner so that the underlying database can scan data from secondary storage in chunks and move such data into memory for use in computations by formulating and generating queries so that multiple computations can be performed using a single data scan. Such queries are able to scale relatively well and at a relatively lower Total Cost of Ownership (TCO). For example, during pre-processing, several pre-processing steps that need the same raw data from inferences could be combined into a single large computation query. Using nested queries and common table expressions (CTEs) of the underlying data engine, different computations can be performed in parallel in the same query, and then the results can be consolidated and stored in underlying pre-processing tables.

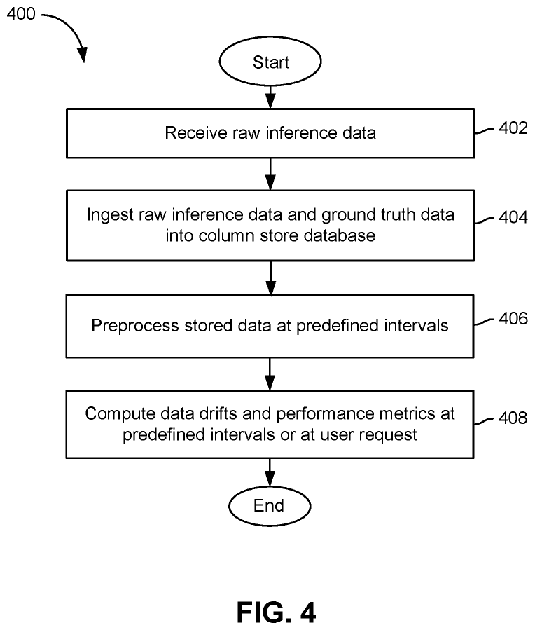

FIG. 4 is a flow diagram of method steps for detecting data drifts and computing performance metrics at scale, according to various embodiments. Although the method steps are described in conjunction with FIG. 1-3, persons skilled in the art will understand that any system configured to perform the method steps, in any order, falls within the scope of the present disclosure.

As shown, a method 400 begins in step 402, where drift detection application 120 receives raw inference data from a machine learning model. The raw inference data can include any technically feasible machine learning prediction or predictions. For example, drift detection application 120 could receive the predictions of a trained classification or regression model.

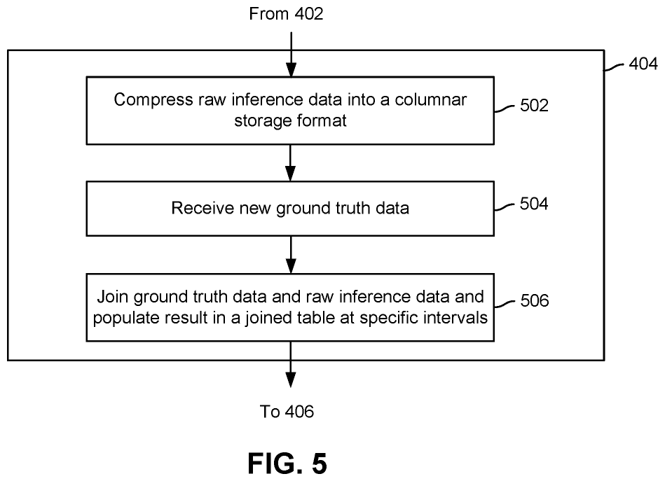

At step 404, drift detection application 120 ingests raw inference data and ground truth data into column store database 115. In some embodiments, drift detection application 120 can efficiently ingest large amounts of data using capabilities of column store database 115 and the ingestion techniques described in greater detail below in conjunction with FIG. 5.

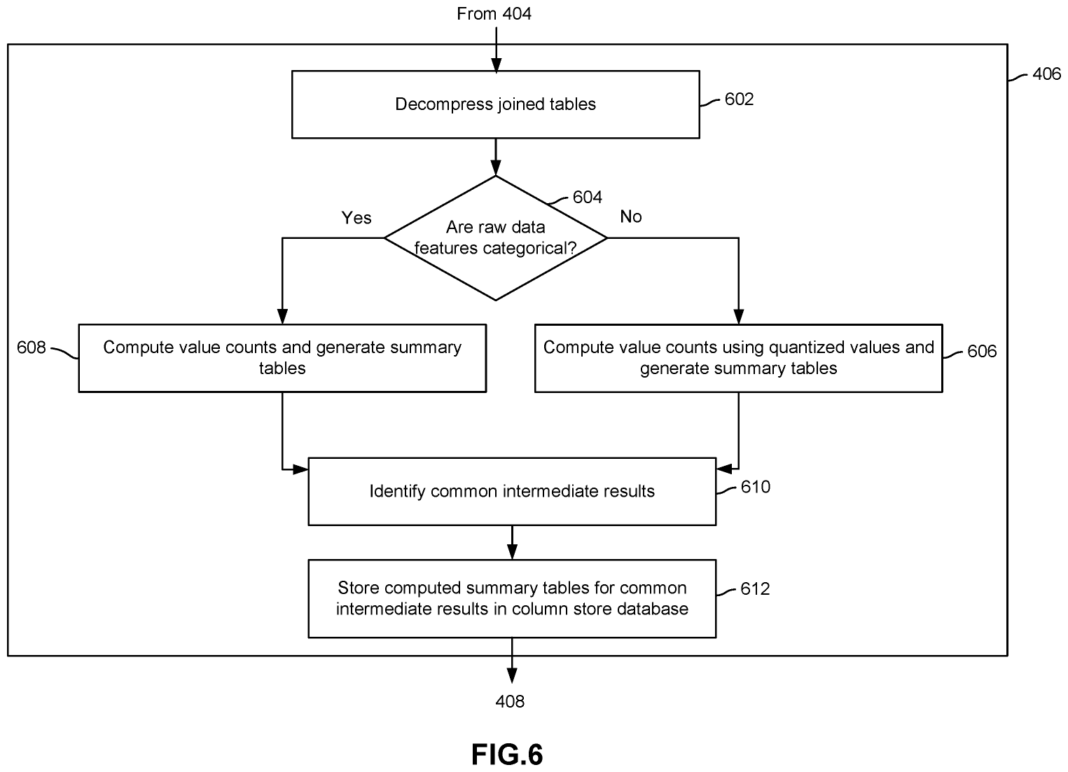

At step 406, pre-processing module 206 pre-processes stored data at predefined intervals. As discussed in greater detail below in conjunction with FIG. 6, in some embodiments, pre-processing module 206 pre-processes compressed data at the granularity of a specific time internal, for example, one day. In such cases, pre-processing module 206 stores aggregated intermediate results in summary tables to avoid re-computation of intermediate results that can be reused multiple times by several computation jobs. In some embodiments, pre-processing module 206 identifies common intermediate results that are potentially used more than once by user- or system-generated queries. In addition, pre-processing module 206 stores intermediate results at specified time intervals in one or more summary tables in the same column store database 115 where source data can also be stored.

At step 408, performance metric computation module 304 and data drift detection module 306 compute data drifts and performance metrics at predefined intervals or in response to user request(s). In some embodiments, both metric computation module 304 and data drift detection module 306 can use previously computed summary tables to compute performance metrics and data drifts on a variety of features, segments, and/or time windows. Both metric computation module 304 and data drift detection module 306 can use modifications of known techniques for computing statistical distances between baseline and target data distributions and/or any other intermediate result that work on aggregated summary tables rather than raw prediction data, without requiring data sampling.

FIG. 5 is a flow diagram of method steps for data ingestion, according to various embodiments. Although the method steps are described in conjunction with FIG. 1-3, persons skilled in the art will understand that any system configured to perform the method steps, in any order, falls within the scope of the present disclosure.

As shown, at step 502, data compression/decompression module 202 compresses and stores raw inference data generated by a trained machine learning model in column store database 115. As described, in some embodiments, data compression/decompression module 202 compresses data using a combination of compression codecs and table schema design parameters that are fine-tuned for the specific requirements of a data drift computation. In some embodiments, data compression/decompression module 202 dynamically defines schemas of tables to store pre-processed data for each type of inference data. The compression codecs used can be selected to provide a high compression ratio and a desired balance between storage requirements and computation efforts. Data compression/decompression module 202 can store compressed data in a columnar storage format in which each feature of data is stored separately. In some embodiments, known compression techniques can be used to compress feature data for storage in column store database 115. In some embodiments, data to be stored in column store database 115 can be ordered in a manner that maximizes compression of the data, and the particular ordering will generally depend on the compression technique used.

At step 504, drift detection application 120 receives new ground truth data. In some embodiments, ground truth data corresponding to particular machine learning model predictions can be received at later times than when the predictions were made. Such ground truth data corresponding to model prediction datapoints can be used to compute performance metrics. In some cases, ground truth data may not be received for some raw inference datapoints.

At step 506, data joining module 204 joins the newly received ground truth data and corresponding raw inference data at specific intervals, and the resulting data is populated in a joined table stored in the column store database 115. Ground truth data and raw inference data can be joined for the purpose of computing performance metrics. In some embodiments, in order to join inference data and ground truth data, data joining module 204 creates four inference mapping tables for each set of machine learning models that take the same input features and generate the same output features: an inference table, a key table, a ground truth table, and a joined table. Data joining module 204 populates the inference table with model predictions. Data joining module 204 associates a timestamp with each inference, and the timestamp can be used to select inferences within a specific time window. In some embodiments, each inference is assigned a unique identifier that can be used to join the inference with corresponding ground truth data that is ingested at a later time. Data joining module 204 creates the key table to permit data to be joined using the unique identifier key instead of timestamps. When ground truth data is received at different intervals, data joining module 204 can populate ground truth table, join new ground truth table rows with corresponding inference table rows using a join technique at regular intervals, and populate the jointed table with the resulting data.

FIG. 6 is a flow diagram of method steps for generating summary tables, according to various embodiments. Although the method steps are described in conjunction with FIG. 1-3, persons skilled in the art will understand that any system configured to perform the method steps, in any order, falls within the scope of the present disclosure.

As shown, at step 602, data compression/decompression module 202 decompresses joined tables created at step 404. It should be noted that the computational expense of decompressing compressed tables can be less than reading uncompressed files from a slow storage. The amount of time saved by decompressing compressed tables can accelerate processing of a large number of datapoints.

At step 604, pre-processing module 206 determines whether raw data features in the inference data are categorical or continuous. If pre-processing module 206 determines that the raw data features are continuous, then method 400 continues to step 606. On the other hand, if pre-processing module 206 determines that the raw data features are categorical data features, then method 400 continues to step 608.

At step 606, pre-processing module 206 computes value counts using quantized values and generates summary tables using the quantized values. Any technically feasible computation technique, such as summing or averaging values, can be used to compute the value counts. In addition, any technically feasible quantization technique can be used to compute quantized values. For example, in some embodiments, continuous values can be rounded before generating summary tables that include the rounded values.

At step 608, pre-processing module 206 computes value counts and generates summary tables using the value counts. Any technically feasible computation technique, such as summing categorical values, can be used to compute the value counts. Pre-processing module 206 then generates summary tables that include the computed value counts.

At step 610, pre-processing module 206 identifies common intermediate results that can be potentially used more than once by drifts computation queries or performance metric computation queries. Pre-processing module 206 also can identify common intermediate results where source data used to compute such intermediate results is immutable. In some embodiments, query module 308 formulates and generates queries in a manner so that multiple computations can be performed in a single data scan. Pre-processing module 206 can identify such queries and combine multiple pre-processing steps that need the same raw data from inferences into a single large computation query.

At step 612, pre-processing module 206 stores computed summary tables for the common intermediate results identified at step 610 in column store database 115. For efficient retrieval of summary tables, pre-processing module 203 can store summary tables for common intermediate results in the same column store database 115 where source data is stored.

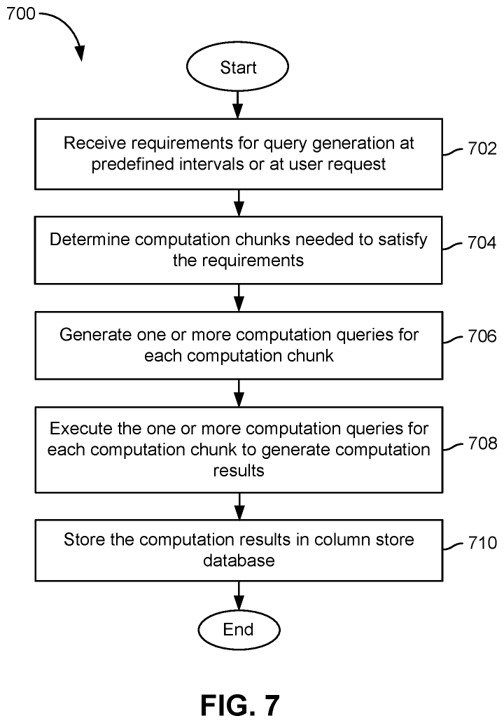

FIG. 7 is a flow diagram of method steps for generating and executing queries, according to various embodiments. Although the method steps are described in conjunction with FIG. 1-3, persons skilled in the art will understand that any system configured to perform the method steps, in any order, falls within the scope of the present disclosure.

As shown method 700 begins in step 702, where query module 308 receives requirements for generating one or more queries at predefined intervals or at a user request. For example, the one or more queries can be generated for computing performance metrics and/or detecting data drifts, described above in conjunction with FIGS. 2-3. In some embodiments, scheduling module 302 or the user can specify the details of a compute request using one or more predefined policy templates. In such cases, query module 308 can transform each policy definition into one or more dynamically generated computation queries. In some embodiments, scheduling module 302 or the user can specify for the compute request custom conditions for feature values and/or custom bin edges for histograms in addition to using standard decile or value count bins for numerical and categorical features.

At step 704, query module 308 determines computation chunks needed to satisfy the requirements. In some embodiments, query module 308 determines what is needed to complete computation of policy requirements associated with the one or more predefined policy templates into computation chunks.

At step 706, query module 308 generates one or more computation queries for each computation chunk. The one or more computation queries are generated dynamically to satisfy the policy requirements associated with the one or more predefined policy templates.

At step 708, query module 308 executes the one or more computation queries for each computation chunk to generate computation results. In some embodiments, the one or more computation queries can be executed in an appropriate order.

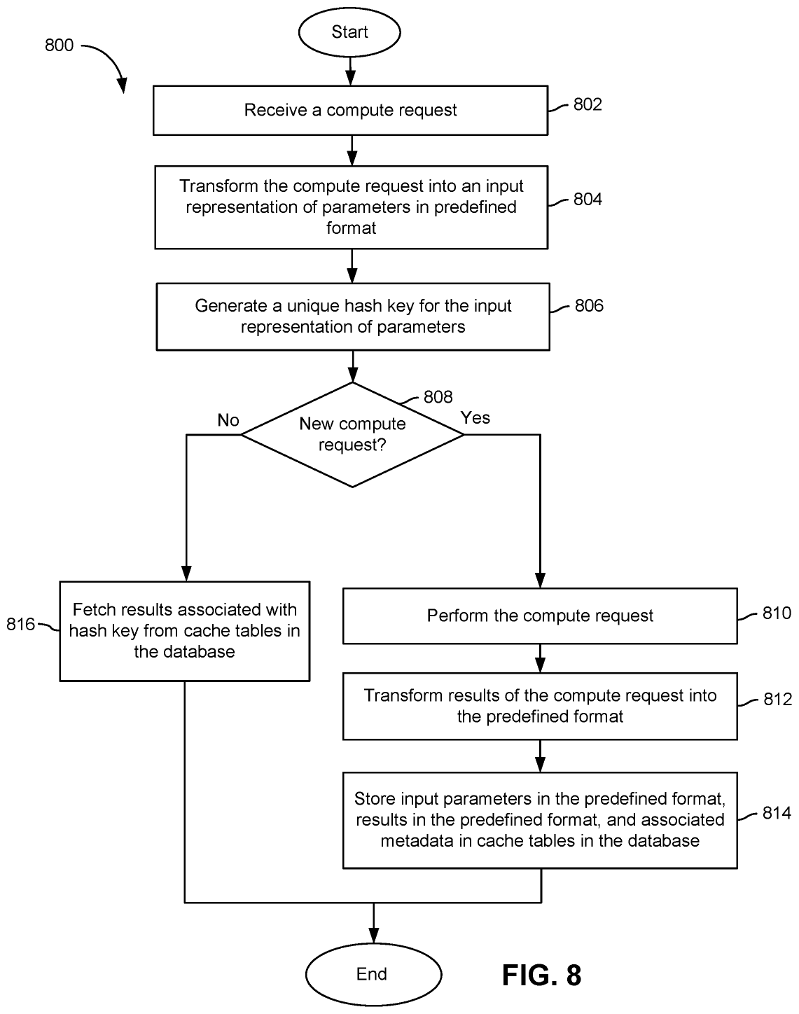

At step 710, query module 308 stores the computation results in column store database 315. In some embodiments, for reusable results, query module 308 caches the reusable results by storing input parameters in the predefined format, the results in the predefined format, and associated metadata in cache tables in the database, as described in greater detail below in conjunction with FIG. 8. Metadata about query execution can also be stored in the cache tables. The caching tables can store results at different levels of granularity for computation requests, e.g., specific computation chunks and complete requests granularities. In addition, in some embodiments, the results can be displayed to a user via, e.g., a web application that allows slice and dice of results as well as viewing of the results in any suitable visual charts.

FIG. 8 is a flow diagram of method steps for processing a compute request and caching reusable results, according to various embodiments. Although the method steps are described in conjunction with FIG. 1-3, persons skilled in the art will understand that any system configured to perform the method steps, in any order, falls within the scope of the present disclosure.

As shown, a method 800 begins in step 802, where performance metric computation module 304 and/or data drift detection module 306 receives a compute request from scheduling module 302 (e.g., at a predefined time interval) or from a user. As described, in some embodiments, scheduling module 302 or the user can specify details of the compute request using one or more predefined policy templates. In such cases, query module 308 can transform each policy definition into one or more dynamically generated computation queries.

At step 804, query module 308 transforms the compute request into an input representation of parameters in a predefined format. For example, query module 308 can transform the compute request into a representation of parameters in a standard JavaScript Object Notation (JSON) format.

At step 806, query module 308 generates a unique hash key for the compute request. In some embodiments, the generated hash key uniquely specifies all steps and input parameters to compute the request.

At step 808, query module 308 searches for the hash key in caching tables to determine if such a computation has been performed in the past. If query module 308 determines that the request is a new compute request that has not been performed in the past, then method 800 continues to step 810.

At step 810, query module 308 performs the compute request. In some embodiments, query module 308 invokes statistical techniques implemented in performance metric computation module 304 and data drift detection module 306 to perform the compute request. The data used in the computations are retrieved from the summary tables generated at step 612, described above in conjunction with FIG. 6.

At step 812, query module 308 transforms results of the compute request into a predefined format. For example, query module 308 can transform results of the compute request into a standard JSON format.

At step 814, query module 308 stores input parameters in the predefined format, results in the predefined format, and associated metadata in cache tables in the database. The cache tables can be stored in any technically feasible data store, such as secondary storage if the cache tables are too large to store in memory. Metadata about query execution can also be stored in the cache tables. The metadata can be analyzed to identify bottlenecks in computations and iteratively improve the computations. In some embodiments, the caching tables can store results at different levels of granularity for computation requests, e.g., specific computation chunks and complete requests granularities.

On the other hand, if query module 308 determines at step 808 that the computation has been performed in the past, then method 800 continues to step 816, where query module 308 fetches results associated with the hash key generated at step 806 from one or more cache tables in the database. In some embodiments, query module 308 can return the results without any modifications.

In sum, techniques are disclosed for detecting data drifts and measuring machine learning model performance at scale. In some embodiments, an ingestion step includes compressing inference data generated by a trained machine learning model in a columnar storage format using a compression technique that balances between storage requirements and computational effort required for data compression and decompression. The compression technique can use table schema design parameters that are selected for the requirements of computing data drifts. The ingestion step can also include joining the inference data with corresponding ground truth data, which can be received later than the inference data, using unique identifier keys, with the results being populated in a joined table. In addition, the ingested compressed data is pre-pre-processed to generate aggregated data at a specified granularity, such as results that are aggregated by day, and the aggregated data is stored in one or more summary tables. Baseline histograms, target histograms, drift distances, and/or performance metrics can be computed for various features, segments, and/or time windows using the summary table(s), without touching raw data. Results generated during such computations can also be cached for re-use.

One technical advantage of the disclosed techniques relative to the prior art is, with the disclosed techniques, data drifts can be detected and performance metrics for trained machine learning model can be computed more accurately than using conventional techniques that rely on data sampling, which can miss critical data drift patterns in the overall data. With the disclosed techniques, all available data points can be considered when computing data drifts. In addition, the disclosed technique can be implemented to detect data drifts and compute performance metrics on commodity hardware, as opposed to specialized computing infrastructure. In that regard, the disclosed techniques make efficient use of available processors and/or cores and memory in a computing system, with the performance increasing linearly as more computing power is made available. These technical advantages provide one or more technological improvements over prior art approaches.

1. In some embodiments, a computer-implemented method for detecting data drifts comprises generating first data by joining inference data output by a trained machine learning model with ground truth data corresponding to the inference data based on one or more identifier keys, performing one or more aggregation operations on the first data to generate second data, and computing a data drift based on the second data.

2. The computer-implemented method of clause 1, wherein the one or more aggregation operations aggregate the first data associated with each time interval included in one or more time intervals.

3. The computer-implemented method of clauses 1 or 2, wherein the one or more time intervals include one or more days.

4. The computer-implemented method of any of clauses 1-3, wherein the one or more aggregation operations include one or more counts of values for categorical feature data included in the inference data.

5. The computer-implemented method of any of clauses 1-4, wherein the one or more aggregation operations include one or more counts of rounded values for continuous feature data included in the inference data.

6. The computer-implemented method of any of clauses 1-5, further comprising compressing the aggregated data in a columnar storage format in which data associated with different features are stored separately.

7. The computer-implemented method of any of clauses 1-6, wherein computing the data drift comprises computing one or more intermediate results based on the second data, caching the one or more intermediate results, and reusing the one or more intermediate results at least once to compute the data drift.

8. The computer-implemented method of any of clauses 1-7, wherein computing the data drift comprises computing at least one of a histogram, a drift distance associated with one or more features, or a time window.

9. The computer-implemented method of any of clauses 1-8, wherein the data drift is further computed based on user input specified via one or more predefined templates.

10. The computer-implemented method of any of clauses 1-9, wherein computing the data drift comprises generating one or more queries based on the user input, and for each query included in the one or more queries generating a first hash based on the query, responsive to determining that the first hash matches a stored hash, returning a stored response associated with the stored hash, and responsive to determining that the first hash does not match any stored hash executing the query on a database to generate a response, and storing the first hash and the response.

11. In some embodiments, one or more non-transitory computer readable media include instructions that, when executed by one or more processors, cause the one or more processors to perform the steps of generating first data by joining inference data output by a trained machine learning model with ground truth data corresponding to the inference data based on one or more identifier keys, performing one or more aggregation operations on the first data to generate second data, and computing a data drift based on the second data.

12. The one or more non-transitory computer readable media of clause 11, wherein the one or more aggregation operations aggregate the first data associated with each time interval included in one or more time intervals.

13. The one or more non-transitory computer readable media of clauses 11 or 12, wherein the one or more aggregation operations include at least one of one or more counts of values for categorical feature data included in the inference data or one or more counts of rounded values for continuous feature data included in the inference data.

14. The one or more non-transitory computer readable media of any of clauses 11-13, wherein the instructions, when executed by the one or more processors, further cause the one or more processors to perform the step of compressing the aggregated data in a columnar storage format in which data associated with different features are stored separately.

15. The one or more non-transitory computer readable media of any of clauses 11-14, wherein computing the data drift comprises computing one or more intermediate results based on the second data, caching the one or more intermediate results, and reusing the one or more intermediate results at least once to compute the data drift.

16. The one or more non-transitory computer readable media of any of clauses 11-15, wherein computing the data drift comprises computing a drift distance between one or more data distributions associated with the inference data and one or more data distributions associated with the ground truth data.

17. The one or more non-transitory computer readable media of any of clauses 11-16, wherein computing the data drift comprises generating one or more queries based on user input, and for each query included in the one or more queries generating a first hash based on the query, responsive to determining that the first hash matches a stored hash, returning a stored response associated with the stored hash, and responsive to determining that the first hash does not match any stored hash executing the query on a database to generate a response, and storing the first hash and the response.

18. The one or more non-transitory computer readable media of any of clauses 11-17, wherein the instructions, when executed by the one or more processors, further cause the one or more processors to perform the step of responsive to determining that the first hash does not match any stored hash, storing metadata associated with the executing the query.

19. The one or more non-transitory computer readable media of any of clauses 11-18, wherein the one or more identifier keys are different from one or more timestamps used as one or more primary keys of a first table that stores the inference data and a second table that stores the ground truth data.

20. In some embodiments, a system comprises one or more memories storing instructions, and one or more processors coupled to the one or more memories that, when executing the instructions, perform the steps of generating first data by joining inference data output by a trained machine learning model with ground truth data corresponding to the inference data based on one or more identifier keys, performing one or more aggregation operations on the first data to generate second data, and computing a data drift based on the second data.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module” or “system.” Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A computer-implemented method for detecting data drifts, the method comprising:
generating first data by joining inference data output by a trained machine learning model with ground truth data corresponding to the inference data based on one or more identifier keys;
performing one or more aggregation operations on the first data to generate second data; and
computing a data drift based on the second data.

2. The computer-implemented method of claim 1, wherein the one or more aggregation operations aggregate the first data associated with each time interval included in one or more time intervals.

3. The computer-implemented method of claim 2, wherein the one or more time intervals include one or more days.

4. The computer-implemented method of claim 1, wherein the one or more aggregation operations include one or more counts of values for categorical feature data included in the inference data.

5. The computer-implemented method of claim 1, wherein the one or more aggregation operations include one or more counts of rounded values for continuous feature data included in the inference data.

6. The computer-implemented method of claim 1, further comprising compressing the aggregated data in a columnar storage format in which data associated with different features are stored separately.

7. The computer-implemented method of claim 1, wherein computing the data drift comprises:
computing one or more intermediate results based on the second data;
caching the one or more intermediate results; and
reusing the one or more intermediate results at least once to compute the data drift.

8. The computer-implemented method of claim 1, wherein computing the data drift comprises computing at least one of a histogram, a drift distance associated with one or more features, or a time window.

9. The computer-implemented method of claim 1, wherein the data drift is further computed based on user input specified via one or more predefined templates.

10. The computer-implemented method of claim 9, wherein computing the data drift comprises:
generating one or more queries based on the user input; and
for each query included in the one or more queries:
generating a first hash based on the query,
responsive to determining that the first hash matches a stored hash, returning a stored response associated with the stored hash, and
responsive to determining that the first hash does not match any stored hash:
executing the query on a database to generate a response; and
storing the first hash and the response.

11. One or more non-transitory computer readable media including instructions that, when executed by one or more processors, cause the one or more processors to perform the steps of:
generating first data by joining inference data output by a trained machine learning model with ground truth data corresponding to the inference data based on one or more identifier keys;
performing one or more aggregation operations on the first data to generate second data; and
computing a data drift based on the second data.

12. The one or more non-transitory computer readable media of claim 11, wherein the one or more aggregation operations aggregate the first data associated with each time interval included in one or more time intervals.

13. The one or more non-transitory computer readable media of claim 11, wherein the one or more aggregation operations include at least one of one or more counts of values for categorical feature data included in the inference data or one or more counts of rounded values for continuous feature data included in the inference data.

14. The one or more non-transitory computer readable media of claim 11, wherein the instructions, when executed by the one or more processors, further cause the one or more processors to perform the step of compressing the aggregated data in a columnar storage format in which data associated with different features are stored separately.

15. The one or more non-transitory computer readable media of claim 11, wherein computing the data drift comprises:
computing one or more intermediate results based on the second data;
caching the one or more intermediate results; and
reusing the one or more intermediate results at least once to compute the data drift.

16. The one or more non-transitory computer readable media of claim 11, wherein computing the data drift comprises computing a drift distance between one or more data distributions associated with the inference data and one or more data distributions associated with the ground truth data.

17. The one or more non-transitory computer readable media of claim 11, wherein computing the data drift comprises:
generating one or more queries based on user input; and
for each query included in the one or more queries:
generating a first hash based on the query,
responsive to determining that the first hash matches a stored hash, returning a stored response associated with the stored hash, and
responsive to determining that the first hash does not match any stored hash:
executing the query on a database to generate a response; and
storing the first hash and the response.

18. The one or more non-transitory computer readable media of claim 17, wherein the instructions, when executed by the one or more processors, further cause the one or more processors to perform the step of responsive to determining that the first hash does not match any stored hash, storing metadata associated with the executing the query.

19. The one or more non-transitory computer readable media of claim 11, wherein the one or more identifier keys are different from one or more timestamps used as one or more primary keys of a first table that stores the inference data and a second table that stores the ground truth data.

20. A system comprising:
one or more memories storing instructions; and
one or more processors coupled to the one or more memories that, when executing the instructions, perform the steps of:
generating first data by joining inference data output by a trained machine learning model with ground truth data corresponding to the inference data based on one or more identifier keys,
performing one or more aggregation operations on the first data to generate second data, and
computing a data drift based on the second data.
